(19) United States
(12) Patent Application Publication
(10) Pub. No.: US 2002/0088730 A1
(43) Pub. Date: Jul. 11, 2002

(54) Flexible package with insert

(75) Inventor: David E. Galomb, Allentown, PA (US)

Correspondence Address: Caesar Rivise, Bernstein, Cohen & Pokotilow, Ltd., 12th Floor, Seven Penn Center, 1635 Market Street, Philadelphia, PA, 19103-2212, US

(73) Assignee: FRES-CO SYSTEM USA, INC.

(21) Appl. No.: 09/756,262

(22) Filed: Jan. 8, 2001

(51) Int. Cl. B65D 25/54; B65D 77/00; B65D 30/22; B65D 33/04; B31B 1/82; B31B 1/60; B31B 19/60

(52) U.S. Cl. 206/459.5; 206/776; 206/782; 383/40; 383/106; 493/222; 493/210

(57) ABSTRACT

A flexible package includes a plastic face piece of a predetermined shape and design. The plastic face piece is positioned over or alternately inserted through one or more die cut openings in at least one wall or panel of the bag and is bonded to the bag material along the peripheral edges of the die cut opening(s). In one preferred embodiment, the plastic face piece creates a 3-dimensional area that stands out from the package and may resemble a toy, a magnet, or a window to view the product inside the bag. In another preferred embodiment, the face piece is in the form of a receptacle that holds a separate product or other device that is removably secured to the package. Examples of separate products include a toy, an electronic game, a dip, a food product, or condiments. The face piece may be attached to either the inner or outer surface of a panel or wall of the bag. If both the bag and face piece are made of compatible materials, they may be joined by heat sealing. If the plastic face piece and the bag are incompatible materials, they may be adhesively bonded together.

### FIELD OF THE INVENTION

This invention relates to flexible packages, and more particularly, to flexible packages for holding products (e.g., foodstuffs) in a hermetically sealed condition (e.g., isolated from the ambient atmosphere), while containing an insert (e.g., window, toy, separate product, condiment, etc.).

### BACKGROUND OF THE INVENTION

Various types of flexible packages for holding particular materials under vacuum therein have been disclosed in the patent literature and are commercially available today.

Examples of packages for holding ground or whole bean coffee are found in the following U.S. Pat. No. 4,576,285 (Goglio); U.S. Pat. No. 4,705,174 (Goglio); U.S. Pat. No. 4,706,174 (Schutten et al.); and U.S. Pat. No. 4,913,561 (Beer); U.S. Pat. No. 4,953,708 (Beer et al.), all of which are incorporated by references herein.

The major advantages of flexible packaging, as compared to relatively rigid packaging (e.g., boxes), are that until the flexible package is filled, the package takes up very little volume, and after it is emptied of its contents, it readily collapses, thereby reducing its volume to approximately that of the unfilled package. The former characteristic is a significant advantage insofar as storage is concerned, while the latter characteristic is a significant advantage from the standpoint of disposability.

One common type of flexible package for holding goods until the package is opened is the so-called “gusseted” package or bag. Typically such a package is formed from a web of flexible stock material (e.g., polyethylene, polyester, co-propylene, metal foil, wax paper and combinations thereof in single or multiple plies) into a tubular body having a face panel, a back panel, and a pair of gusseted sides.

Each gusseted side is formed by a pair of gusset sections and a central fold edge interposed between a pair of outer-fold edges. The lower end of the bag is commonly permanently sealed, e.g., heat-sealed, along a line extending transversely across the width of the bag close to its bottom edge. The top of the bag is commonly sealed transversely across the entire width of the bag in a number of ways to maintain the contents under vacuum until the bag is opened. Such action is frequently accomplished via a readily openable mouth, which when opened, provides access to the contents of the bag.

One-way degassing valves are typically included in flexible packages to enable any gases produced by the particular material within the package to exit from the package, while preventing air from entering into the package through the valve. Examples of such one-way de-gassing valves are shown in U.S. Pat. No. 3,595,467 (Goglio); U.S. Pat. No. 3,799,427 (Goglio); U.S. Pat. No. 4,420,015 (Blaser); and U.S. Pat. No. 5,992,635 (Walters) and the aforementioned Goglio, Schutten et al., Beer and Beer et al. patents, all of which disclosures are incorporated by reference herein

One drawback of many commercially available sealed, flexible packages is that the material disposed therein is not in a form for preferred consumption. Often, other complementary goods are desired for consuming or preparing the product, such as dips as a complementary good for chips, or mustard as a complementary good for pretzels. In addition, some people prefer food that is not spicy, while others prefer food that is very spicy. However, prepared food is packaged with a predetermined amount of spices, and the customer that purchases the food product is generally forced to consume the product with the predetermined amount of spices therein. This presents a problem to a person who desires a food product but does not purchase it because of subjective preferences or medical reasons. For example, a person having high blood pressure may want to purchase a bag of popcorn or pretzels, but does not purchase the food because of the amount of salt therein.

It would be beneficial to provide packaged food to customers in a state that is not very spicy, and allows the customer to season the food according to their preferences.

A person wanting to consume a food product stored in a flexible package of the related art often must separately provide a complementary good (e.g., dip, salt, mustard, cheese, or other flavoring) in addition to the food product to enjoy the product. Customers could enjoy further benefits if other types of premiums were provided with the flexible package, such as, measuring spoons with coffee, or a toy with children's food. Therefore, it would be a benefit to provide a flexible package having a window in a panel for displaying the contents of the package and/or displaying some associated goods or product. It would also be a benefit to provide a flexible package having a three dimensionally shaped window establishing a chamber which together with the interior of the package allows greater product capacity without increasing the package footprint. It would further be a benefit to provide a flexible package incorporating a toy, a dispensing fixture, a receptacle, a retaining unit or complementary goods into the face of a flexible package. All references cited herein are incorporated herein by reference in their entireties.

In my co-pending U.S. patent application Ser. No. 09/468,600 filed on Apr. 27, 2000 entitled Bowl Bag With Sealable Reclosure Means, which is assigned to the same assignee as this invention, there is disclosed a flexible package for foodstuffs and which forms to enable the foodstuff to be eaten directly from the bowl. In some embodiments of the package a utensil, e.g., a spoon, is incorporated in the package to facilitate eating of the foodstuff from the bowl.

### SUMMARY OF THE INVENTION

The invention can be achieved, as a whole or in part, by a package having an interior for holding a product (i.e., a foodstuff) and formed of a flexible material (e.g., laminated film) suitable for being hermetically sealed, with the product being located within the interior of the package. The package includes a front panel and a rear panel. The front and rear panels are connected along peripheral edges of the panels at a first sealed end to define the interior between the panels. At least one of the panels includes a three-dimensionally shaped face piece. In one preferred embodiment, the face piece forms a chamber within the confines of the face piece. In another preferred embodiment, the face piece is a toy or game.

In one aspect of the invention, the chamber projects outside the panel to which the face piece is bonded. In another aspect of the invention, the face piece is transparent and enables a person to see through it into the chamber. In yet another aspect of the invention, the face piece includes a receptacle that removably secures a premium product (e.g., cheese dip, mustard, spices).

The subject invention can also entails a method of making a package having an interior for holding a product (e.g., foodstuff) and formed of a flexible material (e.g., laminated film) suitable for being hermetically sealed, with the product being located within the interior of the package. The method includes the steps of connecting a front panel of a gusseted bag to a rear panel of the bag along peripheral edges of the panels to formed a sealed end, a sealable end and an interior for receiving the product via the sealable end, forming an opening in the front panel, and bonding a three-dimensionally shaped face piece to the front panel adjacent the opening.

### BRIEF DESCRIPTION OF THE DRAWINGS

The invention will be described in conjunction with the following drawings in which like referenced numerals designate like elements and wherein:

FIG. 1 is an isometric view illustrating a flexible package in accordance with a first preferred embodiment of the invention;

FIG. 2 is a sectional view of the flexible package taken along line 2-2 of FIG. 1;

FIG. 3 is a transverse sectional view of the flexible package taken along line 3-3 of FIG. 1;

FIG. 4 is an exploded isometric view of the package of FIG. 1;

FIG. 5 is an exploded isometric view illustrating a flexible package in accordance with a second preferred embodiment of the present invention;

FIG. 6 is an isometric view of the flexible package shown in FIG. 5;

FIG. 7 is an enlarged transverse sectional view of the flexible package taken along line 7-7 of FIG. 6;

FIG. 8 is an exploded isometric view illustrating a flexible package in accordance with another example of the second preferred embodiment of the present invention;

FIG. 8A is an enlarged elevational view of a premium container forming a portion of the flexible package of FIG. 8;

FIG. 8B is an enlarged elevational view similar to FIG. 8A, but taken from the opposite direction;

FIG. 9 is an enlarged sectional view taken along line 9-9 of FIG. 8;

FIG. 10 is an exploded isometric view illustrating a flexible package in accordance with a third preferred embodiment of the invention;

FIG. 11 is an enlarged sectional view of the flexible package taken along line 11-11 of FIG. 10;

FIG. 12 is an exploded isometric view of a flexible package similar to the flexible package shown in FIG. 10;

FIG. 13 is an isometric view illustrating a flexible package in accordance with a fourth preferred embodiment of the invention; and

FIG. 14 is an isometric view illustrating a flexible package in accordance with another aspect of the fourth preferred embodiment of the invention.

### DETAILED DESCRIPTION OF THE PREFERRED EMBODIMENT

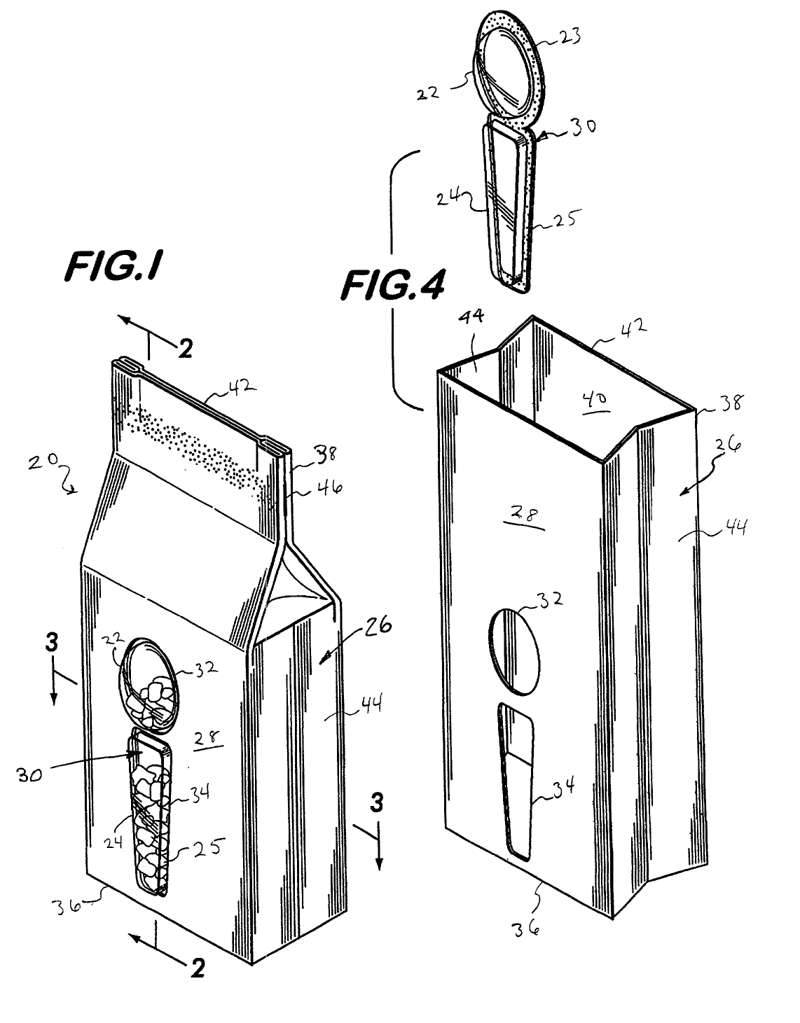

The present invention is directed to a flexible package and method of making the same, and for holding products (e.g., foodstuffs) in a hermetically sealed condition while containing a three-dimensional insert. Referring to FIGS. 1-4, there is shown at 20 a flexible package as constructed in accordance with a first preferred embodiment of the invention. The flexible package 20 basically comprises a flexible gusseted bag 26 having a face piece 30 attached to a panel of the bag 26 (as will be described later). The bag 26 is arranged to hold any particular material (e.g., coffee beans, ground coffee, dry pet food, chemicals, snack food, candy, or other food) and is suitable for packaging small amounts of such materials or for holding larger amounts of such materials.

The bag 26 is formed of a web of any conventional, flexible material, such as a laminated film, and basically includes a front wall or panel 28, a rear wall or panel 40 (FIG. 4), a pair of gusseted sides 44, a bottom or sealed end 36, and a top or sealable upper end 38 terminating at a top marginal edge 42. The front panel 28 is cut or molded to form a pair of die cut openings 32 and 34 for receiving the face piece 30. The face piece 30 is preferably formed of a thermoplastic material, for example, polyethylene (PE), polypropylene (PP) and co-polyester (PET-G).

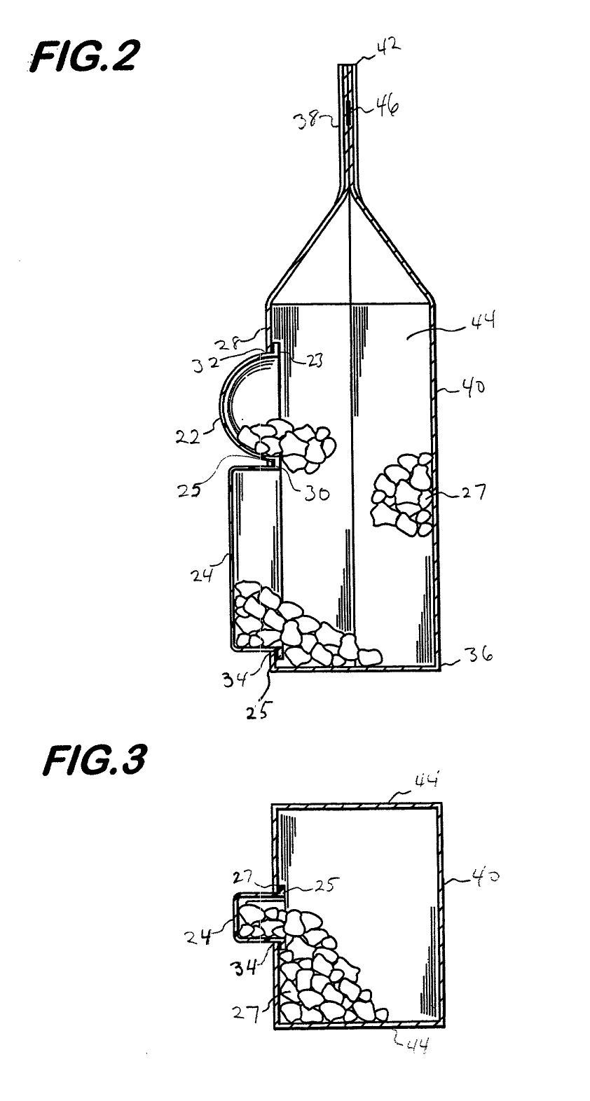

The face piece 30 includes hollow upper and lower windows 22 and 24, respectively. The marginal edges of the windows are in the form of upper and lower flanges 23 and 25, respectively. The flanges 23 and 25 are formed along a common plane and define the periphery of the windows 22 and 24. As shown in FIGS. 2 and 3, the openings 32 and 34 are of the same shape and size as the windows 22 and 24, respectively. The windows 22 and 24 of the face piece 30 are inserted through the openings 32 and 34, respectively, of the front panel 28 until the flanges 23 and 25 engage the interior of the bag 26 about the inner edge of the openings 32 and 34. The flanges 23 and 25 are affixed to the bag 26 by applying a bonding agent 27 or heat treatment between the openings 32 and 34, and the flanges 23 and 25, respectively, to hermetically seal the face piece 30 to the front panel 28 of the bag 26.

In this preferred embodiment, the window 22 has a substantially semispherical convex or dome shape and the window 24 has a shape similar to a channel or parallelepiped with slightly tapering sidewalls. The windows 22 and 24 create a three-dimensional volume that projects out from the flat surface of the front panel 28, and functions as an approach to view the product inside the bag 26. The windows 22, 24 are clear or translucent so that the interior of the bag 26 can be viewed through the window 22 and 24 to observe its content (e.g., foodstuff 27).

The face piece 30 may also provide other benefits, as will be described later. The front panel 28, rear panel 40, and gusseted sides 44 of the bag 26 are integral portions of a single sheet or web of the flexible material, a single or multiple ply or layers of which have been folded and seamed to form a tubular body. The bag 26 is formed of a flexible material so that the bag 26 can be easily folded when empty to use a minimal amount of space for efficient storage. The bag 26 can readily be unfolded and filled with the product (e.g., foodstuff) while maintaining its flexibility to provide resiliency to puncture or breakage. Particularly useful, flexible material for the bag 26 is commercially available from Fres-Co System USA, Inc. of Teleford, Pa., the assignee of this invention.

In a preferred embodiment, the bag 26 has a closeable mouth formed by a peelable seal 46 between the aforementioned panels 28,40 and sides 44 at the sealable end 38 to be readily peeled apart to open the bag 26. The peelable seal 46 can be formed by any conventional means such as those disclosed in the U.S. Pat. No. 4,705,174 (Goglio).

As is conventional in the art, the rear panel 40 of the package 20 includes a fin (not shown) which extends longitudinally along the back of the package 20 from the top edge 42 to the sealed end 36. The fin is preferably located approximately midway between the gusseted sides 44 and is formed by portions of the web material contiguous with the vertical marginal edges of the sheet or web which are brought into engagement with each other and are secured to one another via any conventional sealing technique, such as heat sealing or welding. The fin is generally folded down so it lays substantially flush with the rear panel 40 of the package 20.

The sealed bottom end 36 of the bag 26 is generally sealed closely along a transverse, permanent seam line (not shown). The permanent seam line is formed using any conventional sealing technique, such as that used for the vertical seamed fin.

The bag 26 is filled with a foodstuff 27 (e.g., coffee beans, cereal, popcorn, chips, pretzels, crackers or other food) and sealed along its sealable upper end 38 such that the walls of the package 20 at the sealable upper end 38 may be readily peeled apart when desired to form a mouth for access to the product contained in the interior of the flexible package 20.

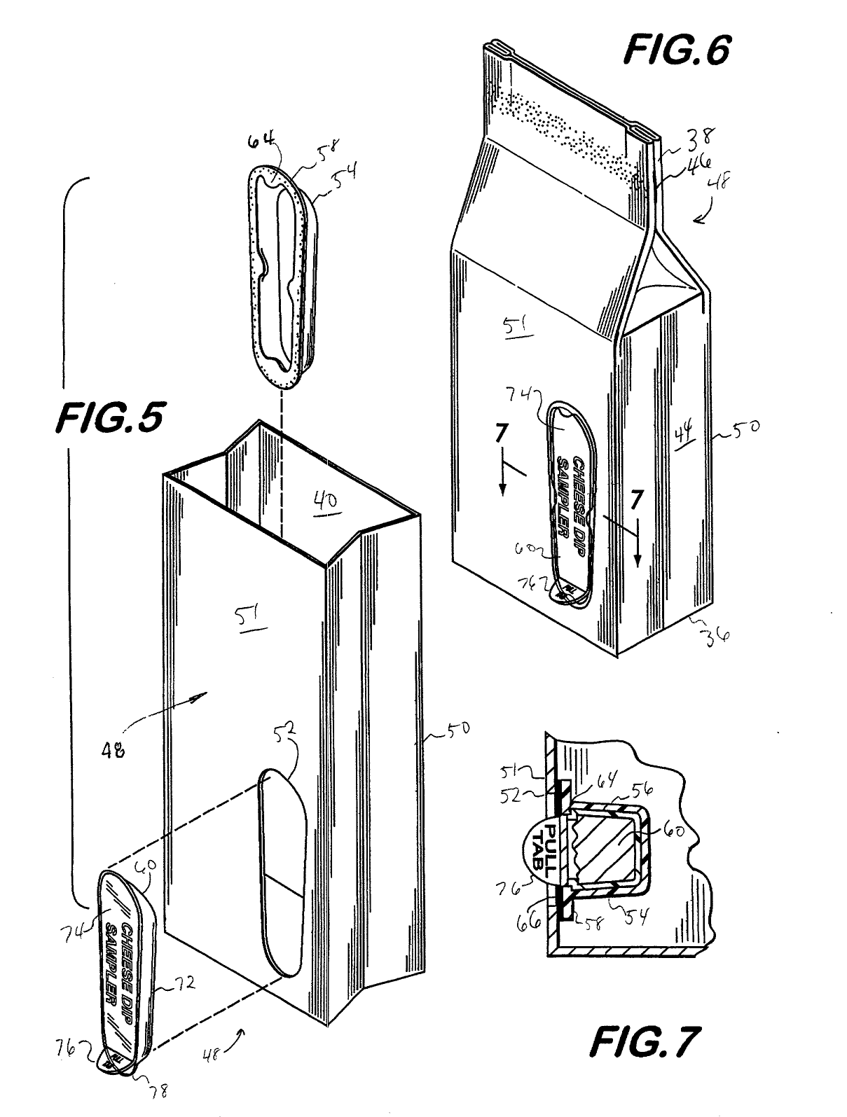

FIGS. 5-7 illustrate an example of a second preferred embodiment 48 of the invention and is similar to the embodiment discussed above and illustrated in FIGS. 1-4. However, unlike the face piece 30 of FIG. 1 which creates a volume extending outward from the plane of the front wall of the package, the face piece 54 of this second embodiment defines a three-dimensional volume extending into the gusseted bag. In particular, as clearly shown in FIGS. 5 and 6, the flexible package 48 is also in the form of a gusseted bag 50, having a concave face piece 54 for holding a premium product (e.g., cheese, mustard, flavored dip) which will be disclosed in greater detail below. The gusseted bag 50 is formed of a flexible material (e.g., laminated film) and basically includes a front panel 51, a rear panel 40, gusseted sides 44, a bottom end 36, and a sealable end 38. As shown, the gusseted bag 50 is substantially similar in construction to the bag 26 shown in FIGS. 1-4. However, the bag 50 includes a single opening 52 on its front panel 51 instead of the two openings 32 and 34 of the bag 26.

Like the face piece 30 described in the previous embodiment, the face piece 54 (which is also referred to as a “holding insert”) is preferably formed of a thermal plastic material (e.g., polyethylene, polypropylene, co-polyester) and is generally flexible. The holding insert 54 is positioned in the opening 52 of the bag 50, such that a peripheral lip or flange 58 of the holding insert 54 engages with a peripheral edge of the opening 52 and the protruding portion 56 extends into an interior of the opening 52. In FIG. 7, the flange 58 is hermetically sealed, preferably to the inside of the gusseted bag 50 via any conventional sealing technique, such as epoxy 66, heat sealing or welding. Alternatively, the flange 58 of the holding insert 54 can be bonded to the peripheral edge of the opening 52 on the exterior of the gusseted bag 50 via a conventional sealing technique, as long as the bond between the flange 58 and the front panel 51 provides a hermetic seal. The bag 50 is filled with a product (e.g., foodstuff) and hermetically sealed along the sealable upper end 38 using a peelable seal 46 or any other conventional sealing technique, e.g., heat sealing, epoxy.

As noted above, the flexible package 48 also includes the premium product 60, which may be a dip or condiment used for enhancing the flavor, and hence the enjoyment, of the foodstuff held in the package. As shown in FIG. 5, the premium product 60 is itself contained in a tub 72. The tub 72 includes a cover 74 that can be removed from the tub 72 to expose the premium product 60 for consumption by pulling a pull tab 76 of the cover away from the tub 72. The premium product 60 is inserted into an interior of the holding insert 54 and is retained therein by holding tabs 64 (FIG. 7) extending inward from an inner peripheral edge of the flange 58. When the premium product 60 is inserted into the holding insert 54, a peripheral edge 78 (FIG. 5) of the premium product's tub 72 abuts against and is held in place by the holding tabs 64, as shown in FIGS. 6 and 7.

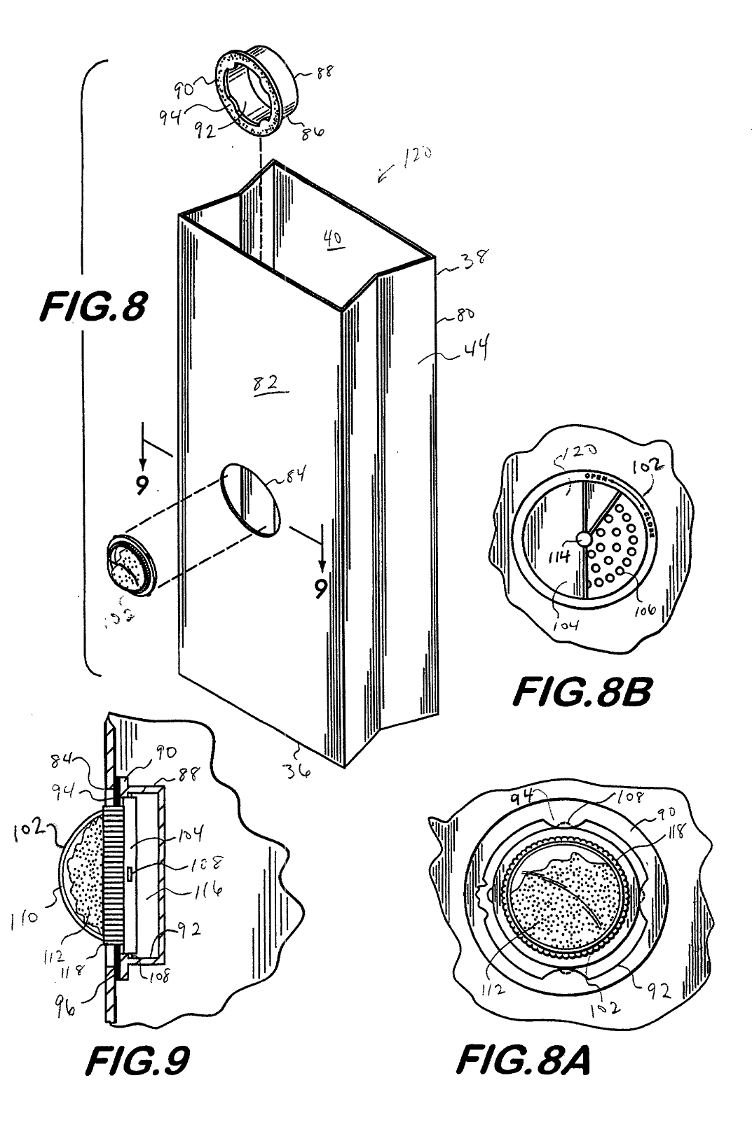

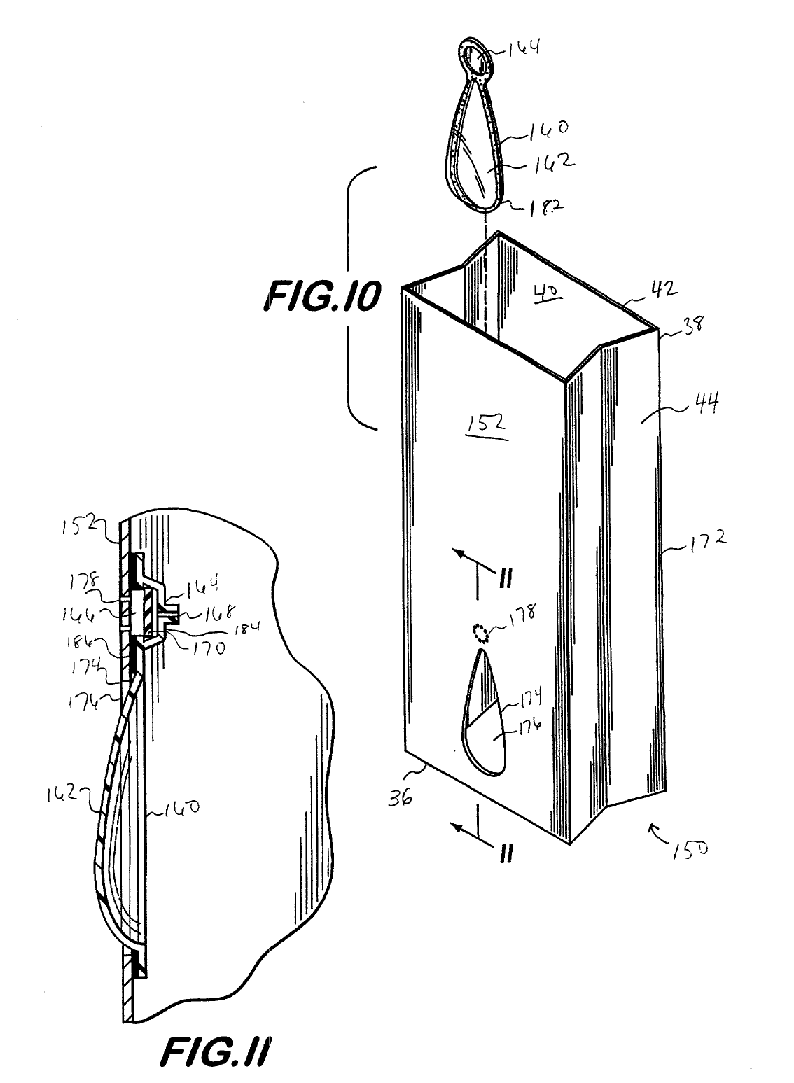

FIGS. 8, 8A, 8B and 9 generally illustrate another aspect of the second preferred embodiment 120 of a package of this invention, where the premium product is a condiment (e.g., salt, pepper, garlic, cheese, seasoning). As shown in FIG. 8, the flexible package 120 is in the form of a gusseted bag 80 and a face piece or holding insert 86. The holding insert 86 has a construction similar to the holding insert 54 of package 48 shown in FIGS. 5-7, except that the holding insert is circular in shape (as will be described later). The bag 80 is constructed and hermetically sealed in a manner similar to the gusseted bags 50 and 26 described above.

The bag 80 is arranged to hold a foodstuff (e.g., popcorn, pretzels, chips) and is formed of any conventional flexible material (e.g., laminated film). The bag 120 includes a front panel 82, a rear panel 40, a pair of gusseted sides 44, and a bottom end 36, similar to the front panel 28, rear panel 40, gusseted sides 44 and bottom end 36, respectively of the bag 26 described above. The front panel 82 is cut or molded to form an opening 84 for receiving the holding insert 86. As shown in FIG. 9, the opening 84 is circular having a diameter equal to or slightly greater than the diameter of the circular side wall 92 of the holding insert 86, and includes a peripheral flange 90. The diameter of the opening 84 is also less than the diameter of the flange 90 of the holding insert 86.

The flange 90 of the holding insert 86 is bonded to an inner peripheral edge 96 of the opening 84 using a conventional sealing technique, such as those previously disclosed herein. The side wall 92 of the holding insert 86 extends from the flange 90 into the protruding portions 88 to define a cavity for holding the premium product, which as shown in FIGS. 8-9, is a saltshaker 102. The holding insert 86 includes holding tabs 94 that extend radially inward and are flexible for receiving and restraining the salt shaker 102. The salt shaker 102 preferably includes a salt shaker top 104 having extending tabs 108 which slidingly engage the side wall 92 of the holding insert 86 when the salt shaker 102 is located in the cavity of the holding insert 86. The extending tabs 108 of the salt shaker 102 and the holding tabs 94 of the holding insert 86 frictionally retain the salt shaker 102 within the opening of the holding insert 86, until the salt shaker 102 is forceably removed from the holding insert 86, for example, by a person wanting to sprinlde the salt on the foodstuff.

The salt shaker 102 also includes a peripheral wall 118 and a transparent cover 110 for containing the salt 112. As shown, the peripheral wall 118 is circular and ribbed so it is easy to grip with one's fingers. The transparent cover 110 is domed, e.g., semispherical, and attaches to the peripheral wall 118, thus forming a dome-like container for the condiment. The three-dimensional shape of the transparent cover 110 allows for easy viewing of the contained condiment from various angles.

When the salt shaker 102 is attached to the holding insert 86 as shown in FIGS. 8A and 9, the salt shaker top 104 has a diameter less than or about equal to the inner diameter of the flange 90, and greater than the distance between opposing holding tabs 94. In addition, the extending tabs 108 are flexible and protract to engage the inner wall 92 of the holding insert 86. In this manner, the top 104 is insertable beyond the holding tabs 94 into the interior 116 of the holding insert 86 for frictional engagement with the inner wall 92 of the holding insert 86.

FIG. 8B illustrates a longitudinal view of the salt shaker top 104, which includes a cover 120 that controls the flow of salt 112 out of the shaker 102. The cover rotates about pivot 114 and exposes the openings 106, which provides communication between the salt 112 and the exterior environment. When not attached to the holding insert 86, the salt shaker top 104 can be rotated about the pivot 114 to expose the openings 106 in the top 104 and allow the salt 112 to permeate from the salt shaker 102 through the openings 106. As the cover 120 rotates about pivot 114, more openings 106 are exposed so that more salt can be disposed from the shaker 86. Accordingly, a person can adjust the rate of extraction of the salt 112 from the saltshaker 102 by rotating the cover 20 to expose a desired number of openings 106. The salt shaker is preferably made of plastic, but can be made of any materials sufficient for storage and dispensing the salt 112.

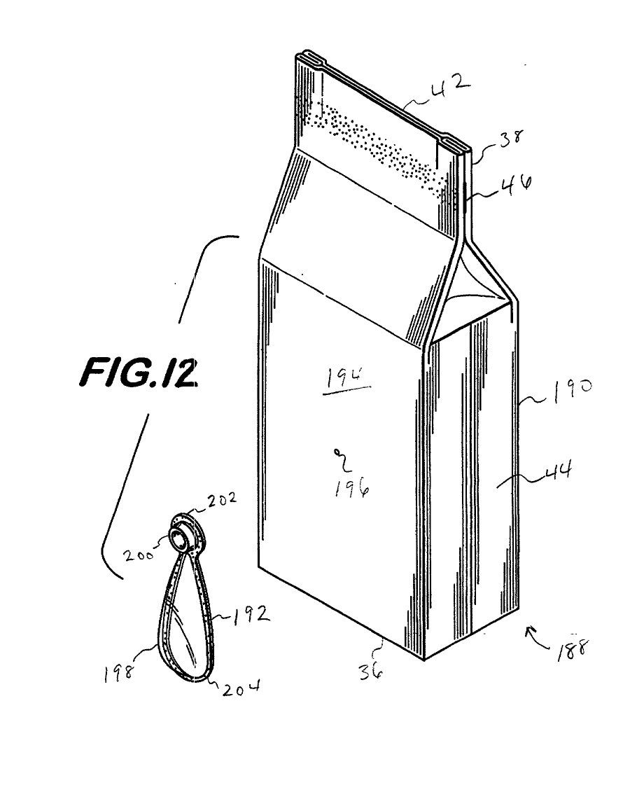

FIGS. 10 and 11 illustrate a third preferred embodiment of the invention wherein a sealed flexible package 150 allows air to escape from its interior, and inhibits air from flowing into its interior. This package 150 is preferably used for storing food products (e.g., coffee) that emit gas to allow the gas to escape while keeping the food product “fresh” and inaccessible to ambient air. The flexible package 150 is in the form of a gusseted bag 172 having a face piece 160.

The gusseted bag 172 is formed of any conventional, flexible material (e.g., laminated film), and basically includes a front panel 152, a rear panel 40, gusseted side panels 44, a bottom panel 36, and a sealable end 38. The gusseted bag 150 is constructed and hermetically sealed at its sealable end 38 in a manner similar to the gusseted bags 26 and 50 discussed above. The front panel 152 is cut or molded to form a die cut opening 176 and die cut airways 178 in the form of a ring of small apertures (FIGS. 10 and 11). As shown in FIG. 11, the die cut opening 176 has a teardrop shape and is much larger in area than the die cut airways 178, which merely need to be large enough to allow the passage of air or vapor from the package. While the die cut opening 176 is teardrop shaped, its shape is merely exemplary of various shapes for inserts as contemplated by this invention and as will be readily understood by a skilled artesian.

As shown in FIG. 11, the face piece 160 is bonded to the back side of the front panel 152 by an adhesive 186 (e.g., epoxy) or heat treatment (e.g., heat sealing) in a manner similar to that described previously for the face piece 30. The face piece 160 is preferably constructed of a plastic material and includes a window 162 and a degassing valve 164. Like the windows 22 and 24, the window 162 is preferably transparent and has a three dimensional convex shape. In particular, the window 162 has a teardrop shaped periphery, to fit through the teardrop shaped opening 176. The periphery of the window is a planar flange 182. In accordance with the other aspects of the invention, the window 162 may be used for viewing the material in the bag 172, or may include a premium product, such as a dip, spice, or measuring spoon for measuring the product, (e.g., coffee beans or grounds) for making coffee.

The degassing valve 164 may preferably be constructed somewhat like those of the U.S. patents referred to previously and whose disclosures are incorporated by reference herein. The exemplary valve 164 shown in FIG. 11, includes a cavity 166 that retains a resilient or rubber disk 170 that allows air or gases produced by the product within the package 150 to exit out of the package 150 through the cavity 166 in one direction. A rear side 184 of the degassing valve 164 adjacent the rubber disk 170 includes a channel 168 therethrough to provide communication between the cavity 166 and the die cut airways 178. The degassing valve allows air to permeate through the cavity 166 via the channel 168 and the rubber disk 170, but does not allow to flow from the cavity 166 to the channel 168.

The planar flange 182 surrounding the window 162 is sealed about the die cut opening perimeter 174. The planar flange 182 surrounding the degassing valve 164 is also sealed about the die cut airways 178. The seals are airtight so no air can escape between the planar flange 182 and the opening perimeter 174. When sealed, the air in the cavity 166 of the degassing valve 164 communicates with the ambient atmosphere outside the gusseted bag 172 via the die cut airways 178. As noted above, the air can permeate from the interior of the gusseted bag 172 to outside the gusseted bag 172 via the degassing valve 164, but cannot flow in the opposite direction because the degassing valve 164 is a one-way valve. Accordingly, the flexible package 150 enables gasses which may be produced by the foodstuff (e.g., coffee) contained within the bag 172 after it is hermetically sealed to permeate to the ambient air while providing a three-dimensional window for viewing the foodstuff.

FIG. 12 illustrates another flexible package 188 in accordance with the third preferred embodiment disclosed above and illustrated in FIGS. 10 and 11, wherein the face piece is attached to the outside of the bag as an alternative to being attached to the inside of the bag. The flexible package 188 shown in FIG. 12 is in the form of a gusseted bag 190 having a face piece 192 similar to the face piece 160 of the gusseted bag 172 shown in FIG. 10. However, as shown in FIG. 12, the face piece 192 is attached to the outside of the front panel 194, and not to the inside of the front panel 194. Since the face piece 192 is attached external to the front panel 194, an opening is not required in the front panel 194 to accommodate the window 198.

The face piece 192 includes a domed (convex) window 198 and a degassing valve 200. When secured to the front panel of the package 188, the degassing valve 200 overlies an opening 196 in the front panel 194 to allow air to permeate from the interior of the package 188 through the valve 200 to the ambient atmosphere. The valve 200 can be of any suitable construction like described earlier and prevents air from entering the package 188 through it. In this manner, when the degassing valve 200 is bonded to the front panel 194, and the sealable upper end 38 of the package is hermetically sealed, as described above using an adhesive or heat treatment, gas can escape the bag 190 via the valve 200, but cannot penetrate into the bag 190. Accordingly the foodstuff sealed in the flexible package 188 maintains its freshness while the package 188 maintains its size.

The periphery of the degassing valve 200 is an upper planar flange 202, and the periphery of the window 198 is a lower planar flange 204. The upper planar flange 202 is sealed to the front panel 194 about the opening 196. When the upper planar flange 202 and the front panel 194 are bonded, the lower planar flange 204 may be, but is not necessarily, bonded to the front panel 194. The window 198 of the face piece 192 may be used for viewing the material within the bag 188 if the portion of the front panel 194 under the window 198 is clear. In addition, the window 198 may be used as a measuring device for spooning out the foodstuff within the bag 190 upon detachment of the face piece 192 from the front panel 194.

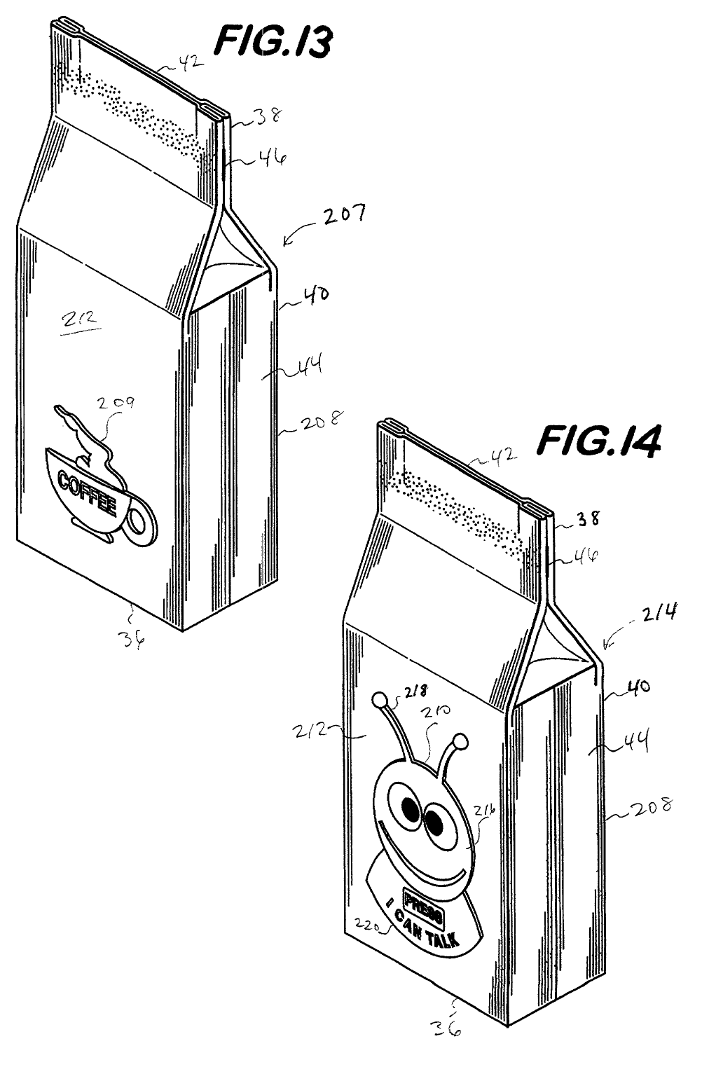

FIGS. 13 and 14 illustrate a fourth preferred embodiment of the invention with each figure showing a different shaped face piece. The face pieces of these figures are each attached to their respective gusseted bag without use of an opening in the front panel of the bag. These face pieces are three dimensional, e.g., extend outward (are convex) and can be removed from their respective bag while maintaining the hermetic seal of the bag.

In FIG. 13, the flexible package 207 includes a gusseted bag 208 and a face piece 209. In FIG. 14, the flexible package 214 includes the gusseted bag 208 and a face piece 210. The gusseted bag 208 is preferably constructed of a flexible material (e.g., laminated film) and is hermetically sealed by any conventional sealing technique discussed above. As shown, the gusseted bag 208 includes a front panel 212, a rear panel 40, a bottom panel 36, gusseted sides 44, and is bonded at sealable end 38 by an adhesive 46. The front panel 212 does not include an opening.

The face pieces 209 and 210 are preferably formed of a flexible material (e.g. plastic) and are bonded to the bag 212 using any conventional sealing technique, as disclosed above. The plastic face piece 209 shown in FIG. 12 may indicate the foodstuff sealed in the bag 212, and may also provide other functions, such as a magnet for use on, for example, a refrigerator or other magnetic panel.

The exemplary face piece 210 shown in FIG. 14 is in the form of an electronic toy. The electronic toy includes a face 216 having antenna 218 that is connected to a base 220. The base 220 is constructed as readily known by a skilled artesian to transmit a sound upon depression thereof. The face piece 210 is removably attached to the front panel 212 using any conventional sealing technique as disclosed above. A skilled artesian would readily understand that other electronic devices could be applied as the face piece 210 to the bag 208, such as a calculator or small computer game.

It should be apparent from the aforementioned description and attached drawings that the concept of the present application may be readily applied to a variety of preferred embodiments, including those disclosed herein. Thus the face pieces can be of any size and/or shape, can be concave or convex, can be used to house a variety of items, and can be affixed to a panel of a flexible package directly over the panel or over or in an opening in the panel. Moreover, the package need not be hermetically sealed nor need it include a peelably openable mouth.

Without further elaboration, the foregoing will also fully illustrate the invention that others may, by applying current or future knowledge, readily adapt the same for use under various conditions of service.

I claim:

1. A package having an interior for holding a product and formed of a flexible material suitable for being hermetically sealed, with the product being located within said interior of said package, comprising:
a front panel;
a rear panel, said rear panel being connected to said front panel at a first sealed end, to form said interior between said panels; and
a three-dimensionally shaped face piece to form a hollow chamber within the confines of said face piece.

2. The package of claim 1 wherein said chamber projects outside said panel to which said face piece is bonded.

3. The package of claim 1 wherein said face piece is transparent or translucent to enable a person to see through it into said chamber.

4. The package of claim 2 wherein said face piece is transparent or translucent to enable a person to see through it into said chamber.

5. The package of claim 1 wherein said face piece comprises a separate member secured to said at least one of said panels.

6. The package of claim 5, wherein said at least one of said panels includes a die cut opening for receiving said face piece, said face piece being located in said die cut opening and bonded to said flexible material of the one of the panels along a peripheral edge of the die cut opening.

7. The package of claim 5, wherein said face piece is formed of plastic or copolyester.

8. The package of claim 5, wherein said face piece is substantially transparent or translucent for visually exposing the product.

9. The package of claim 5, wherein said face piece includes a receptacle to removably secure a foreign object.

10. The package of claim 9, wherein said foreign object includes a condiment.

11. The package of claim 5, wherein said face piece includes an interactive electronic display.

12. The package of claim 1, wherein said at least one of said panels includes a die cut opening, the package further comprising a receptacle inserted into the die cut opening and bonded to the flexible material of said at least one of said panels along a peripheral edge of the die cut opening for receiving said face piece and separating said face piece from the product, such that said face piece is removably secured to said receptacle and is attached to said at least one of said panels via the receptacle.

13. The package of claim 12, wherein said face piece encloses an object.

14. The package of claim 13, wherein said object is a condiment.

15. The package of claim 5, wherein said face piece includes a toy.

16. The package of claim 5, wherein said face piece is bonded to the one of the panels by a heat seal or epoxy.

17. The package of claim 5, wherein said face piece is molded to form a receptacle designed to contain a rubber disk and the face piece communicates through said at least one of said panels to form a degassing valve.

18. The package of claim 17, wherein said face piece further includes a cap for retaining said rubber disk with the receptacle.

19. The package of claim 5, wherein said face piece includes a spoon.

20. A method of making a package having an interior for holding a product and formed of a flexible material suitable for being hermetically sealed, with the product being located within said interior of said package, comprising:
providing a front panel formed of the flexible material;
connecting a rear panel formed of the flexible material to said front panel to form a sealed end, a sealable end and an interior for receiving the product via said sealable end; and
coupling a three-dimensionally shaped face piece to at least one of said panels, said face piece forming a chamber within its confines.

21. The method of claim 20, additionally comprising the step of providing an opening in said at least one of said panels.

22. The method of claim 21, further comprising:
inserting said face piece into said opening;
bonding said face piece to said flexible material of said panel along a peripheral edge of said opening, and
inserting an object into said face piece, such that said object is removably secured to said face piece.

23. A package having an interior for holding a product and formed of a flexible material suitable for being hermetically sealed, with the product being located within said interior of said package, comprising:
a front panel;
a rear panel, said rear panel being connected to said front panel at a first sealed end, to form said interior between said panels; and
a three-dimensionally shaped face piece removably secured to and protruding from the front panel;

24. The package of claim 23, wherein said face piece is a toy.
